(19) United States
(12) Patent Application Publication
(10) Pub. No.: US 2007/0083767 A1
(43) Pub. Date: Apr. 12, 2007

(54) Apparatus and method for detecting falsification of external data

(75) Inventor: Kenya Kumamoto, Kawasaki-shi (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/512,234

(22) Filed: Aug. 30, 2006

(30) Foreign Application Priority Data
Aug. 31, 2005 (JP) 2005-251681

(51) Int. Cl. G06F 12/14

(52) U.S. Cl. 713/189

(57) ABSTRACT

An external data falsification detecting system includes a data acquirer section configured to acquire an external data at a time of system start and during system operation. A normal HASH value of the external data is previously stored in a storage unit. A comparator section calculates a HASH value of the acquired external data, compares the normal HASH value and the calculated HASH value, and determines that the external data was falsified such that a predetermined operation limitation is carried out, when the normal HASH value and the calculated HASH value are not coincident with each other.

### BACKGROUND OF THE INVENTION

1. Field of the Invention

The present invention relates to an apparatus and method for detecting falsification of an external data.

2. Description of the Related Art

In a semiconductor device, an application program is stored in a built-in storage unit and is read out and executed. However, there are semiconductor devices designed to read out an application program from an external storage unit and to execute the application program. This is because the modification and update of the application programs are easy as compared with a case that the application program is stored in the built-in storage unit. In this case, however, the semiconductor device needs a built-in storage unit having so larger storage capacity that all of the application programs can be stored. Thus, in such a case, the size of the semiconductor device becomes larger so that the price thereof becomes high. Therefore, the use of the external storage unit sometimes has an advantage over the case of containing the built-in storage unit.

On the other hand, a flash memory used as the external storage unit has a possibility that data is easily falsified by a hacker or the like. When the falsified code is executed, a secret data within the semiconductor device is stolen and an apparatus using the semiconductor device is erroneously operated.

For this reason, in the semiconductor device using the external storage unit, it is strongly demanded that the falsification detection of the external data stored in the external storage unit can be carried out.

In conjunction with the above description, a semiconductor device having an encrypting unit is disclosed in Japanese Laid Open Patent Application (JP-P2004-96666A), and the semiconductor device has a falsification detecting system of an external data. In this conventional example, an encrypted application program stored in an external memory is decrypted through a program decrypting engine of a program executing section in an external interface in a booting process and taken into a HASH calculating section to calculate a HASH value. Then, this calculated HASH value and a HASH value previously stored in a normal region of a security memory are compared to check whether or not the application program is falsified. If the HASH values are coincident with each other, the control is transferred to the external memory and the application program is executed. If the HASH values are not coincident with each other, any illegal action is supposed to be taken, and a process for an illegal access is executed.

However, the method of comparing the HASH values only at the time of system start and checking the falsification of the external data cannot detect the falsification of the data in the external memory after the system start. The following falsifications are known as examples of the falsification of the external data during the system operation:
(1) During the system operation, the external memory itself is replaced with a different memory; and
(2) A normal external memory and an illegal external memory in which an illegal code is written are prepared, and signal lines connected to the memories are switched by a switch. In the check at the time of system start, the switch is switched to the side of the normal external memory, and after the check completion, the switch is switched to the side of the illegal external memory side.

Also, even if a code of an external memory is falsified during execution of an application program after the application program is read out from the external memory at the time of start and store in a built-in memory, there is no influence on a system itself. In such a case, however, it is necessary to contain the built-in memory having a storage capacity equal to the size of the application program to be executed. This leads to the increase in the device size.

In this way, a semiconductor device is desired which can detect the falsification of external data without any increase in size of the device, not only at the time of system start but also-during a system operation, and a method of detecting the falsification of the external data.

### SUMMARY OF THE INVENTION

In an aspect of the present invention, an external data falsification detecting system includes a data acquirer section configured to acquire an external data at a time of system start and during system operation. A normal HASH value of the external data is previously stored in a storage unit. A comparator section calculates a HASH value of the acquired external data, compares the normal HASH value and the calculated HASH value, and determines that the external data was falsified such that a predetermined operation limitation is carried out, when the normal HASH value and the calculated HASH value are not coincident with each other.

Here, the acquisition of the external data by the data acquirer section and the calculation, comparison and determination by the comparator section during the system operation may be carried out at irregular timing based on a random number.

Also, the external data falsification detecting system may further include a random number generator having a shift register and configured to generate the random number.

Also, the random number generator may generate the random number in response to a first clock signal and a second clock signal which is not synchronous with the first clock signal.

Also, the first clock signal may be a system clock signal, and the second clock signal may be obtained by excluding some clock pulses from the system clock signal.

Also, the external data falsification detecting system may further include a frequency setting circuit configured to optionally set a frequency of the acquisition of the external data by the data acquirer section and the calculation, comparison and determination by the comparator section during the system operation.

Also, the external data falsification detecting system may further include a check control circuit configured to control the data acquirer section and the comparator section in response to an input command.

Also, the external data falsification detecting system may further include a CPU. The storage unit may further store a detection program, and the CPU may execute the detection program to operate as the comparator section.

In another aspect of the present invention, a method of detecting falsification of an external data, is achieved by acquiring an external data at each of timings during a period from start to end in a system using the external data; by calculating a HASH value of the acquired external data; by comparing a normal HASH value and the calculated HASH value; and by determining that the external data was falsified such that a predetermined operation limitation is carried out, when the normal HASH value and the calculated HASH value are not coincident with each other.

Here, the timings may be random.

Also, the method may be achieved by further generating random numbers; and determining the timings based on the random numbers.

Also, the generating random numbers may be achieved by generating the random numbers in response to a first clock signal and a second clock signal which is not synchronous with the first clock signal.

Also, the first clock signal may be a system clock signal, and the second clock signal may be obtained by excluding some clock pulses from the system clock signal.

Also, the method may be achieved by further optionally setting a frequency of the timings.

Also, the method may be achieved by further controlling the acquiring, the calculating, and the comparing in response to an input command.

In another aspect, the present invention is related to a computer-readable software product for realizing a method of detecting falsification of an external data. The method may be achieved by acquiring an external data at each of timings during a period from start to end in a system using the external data; by calculating a HASH value of the acquired external data; by comparing a normal HASH value and the calculated HASH value; and by determining that the external data was falsified such that a predetermined operation limitation is carried out, when the normal HASH value and the calculated HASH value are not coincident with each other.

Also, the timings may be random.

Also, the method may be achieved by further generating random numbers; and determining the timings based on the random numbers.

Also, the generating random numbers may be achieved by generating the random numbers in response to a first clock signal and a second clock signal which is not synchronous with the first clock signal.

Also, the method may be achieved by further optionally setting a frequency of the timings.

### BRIEF DESCRIPTION OF THE DRAWINGS

FIG. 1 is a flow chart showing an operation of a conventional falsification detecting system for an external data stored in an external memory;

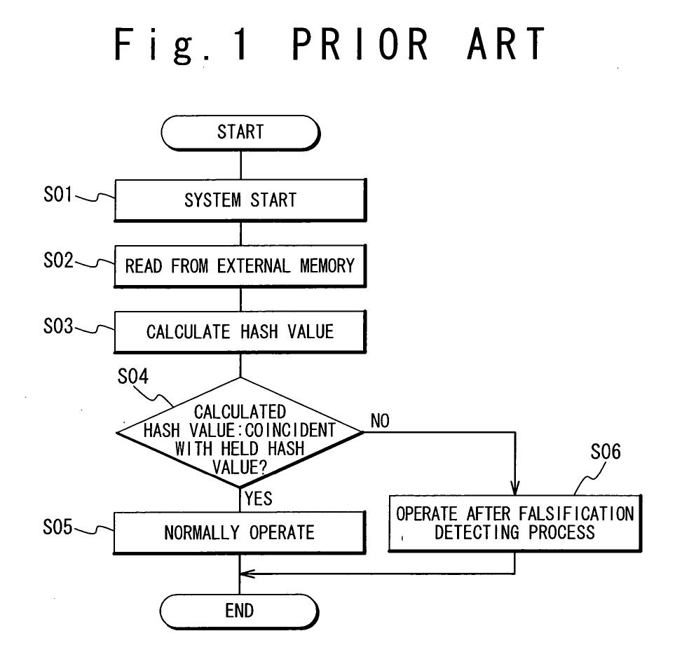

FIG. 2 is a block diagram showing a configuration of an external data falsification detecting system according to a first embodiment of the present invention;

FIG. 3 is a block diagram showing the configuration of a random number generator contained in the external data falsification detecting system according to the first embodiment;

FIG. 4 is a block diagram showing the configuration of a frequency setting register & an interruption signal generating circuit included in the external data falsification detecting system according to the first embodiment;

FIG. 5 is a flow chart showing an operation of the external data falsification detecting system according to the first embodiment; and

FIG. 6 is a diagram showing levels of safety attained by the embodiments of the present invention.

### DESCRIPTION OF THE PREFERRED EMBODIMENTS

Hereinafter, an external data falsification detecting system of the present invention will be described in detail with reference to the attached drawings.

The external data falsification detecting system according to the present invention can detect the falsification of an external data stored in an external storage unit or external memory not only at the time of system start but also during system operation. In particular, if the falsification detection of the external data is carried out periodically, there is a fear that the detection timing is estimated. Therefore, the external data is read at a random timing, and a HASH value of the external data is calculated to compare with a HASH value previously set. In the present invention, since the external data is not taken into a built-in storage unit of the system, the external data falsification detecting system is not required to have a storage unit having the same capacity as the external storage unit. Therefore, while reserving the safety of the system, it is possible to miniaturize the entire configuration of the system.

### First Embodiment

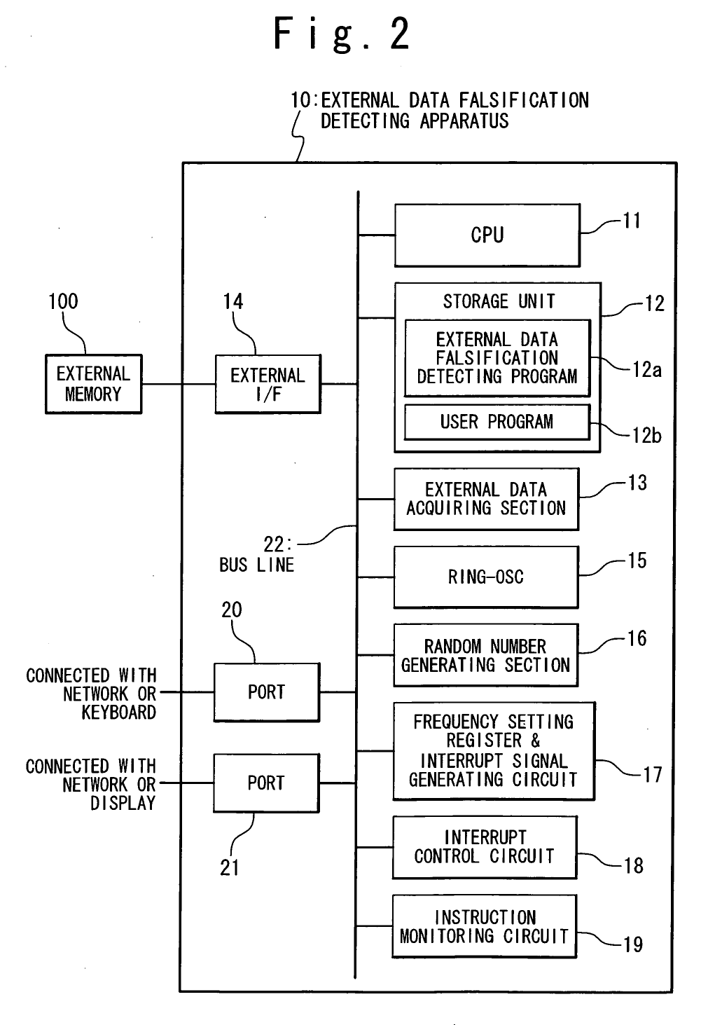

FIG. 2 shows the schematic configuration of the external data falsification detecting system according to the first embodiment of the present invention. In the external data falsification detecting system 10 in the first embodiment, the entire function of the external data falsification detecting system is realized through installation of a semiconductor chip having a partial function in a microcomputer. When the semiconductor chip having the partial function is installed in the microcomputer, an external interface (I/F) unit for acquiring an external data, CPU, a storage unit such as RAM and ROM, and an interruption control circuit and the like, which are installed in advance in the microcomputer, are used in their original states as respective functions in the external data falsification detecting system in the first embodiment.

The external data falsification detecting system 10 in the first embodiment is connected through an external I/F 14 to an external memory 100. Then, an external data such as an application program has been stored in the external memory 100 and are read and executed, thereby attaining any application function.

The external data falsification detecting system 10 in the first embodiment has a data acquirer section 13 for acquiring the external data stored in the external memory 100 through the external I/F 14; a storage unit 12 that stores in advance an external data falsification detecting program 12a, a user program 12b and a normal HASH value serving as a HASH value of the external data; a CPU 11 that attains a function as a HASH value comparator section by reading the external data falsification detecting program 12a and the normal HASH value which are stored in advance in the storage unit 12; an (input) port 20 for inputting an instruction to the apparatus through a network, a keyboard and the like; and an (output) port 21 for outputting the process result processed by the apparatus 10 according to this embodiment to the network, a display and the like. The storage unit 12 may be configured to be built in the CPU 11 as a memory built in the CPU 11.

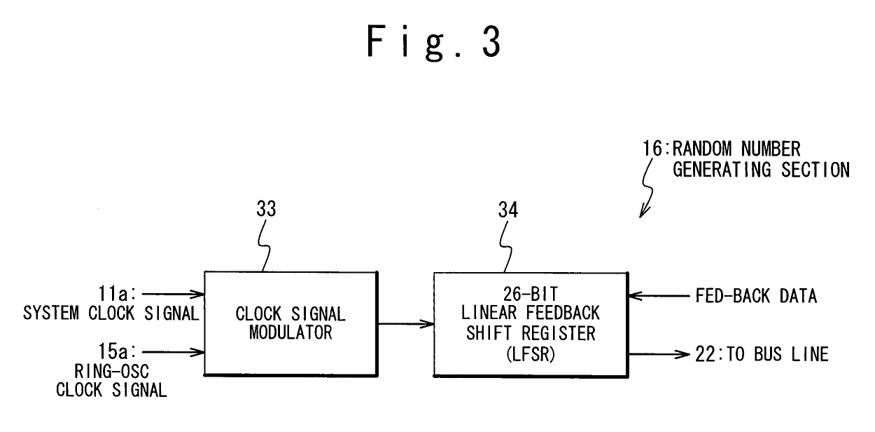

Also, the external data falsification detecting system 10 in this embodiment has a ring oscillator (Ring-OSC) 15 that generates a clock signal asynchronous with a system clock signal to operate the CPU 11; and a random number generator 16. FIG. 3 shows the schematic configuration of the random number generator 16. The random number generator 16 in this embodiment has a 26-bit counter 34 which has a 26-bit linear feedback shift register; and a clock modulation 33 for modulating a system clock signal 11a and a Ring-OSC clock signal 15a and supplying to the counter 34. The counter 34 generates a pseudo random number in accordance with a feedback data inputted thereto and the clock signal from the clock modulation 33 and transmits to a bus line 22. However, the random number generator 16 constituted by the counter 34 is the pseudo random number generator, in short. Thus, this has a defect that the estimation of the generated random number is easy. Therefore, in the first embodiment, the random number generator 16 is realized for generating the random number whose estimation is difficult.
(a) This is configured to have the large counter configuration, as compared with a bit length of a random number to be used.

In the first embodiment, the bit length of the random number to be generated has a maximum of 5 bits. However, this is configured to have the counter configuration of a 26-bit length.
(b) A constant shift clock signal is not used. In case of a usual counter, the system clock signal is used as a shift clock signal. However, in such a case, the shift timing and the number of times of the shift are easily estimated, and the estimation of the generated random number becomes easy. On the contrary, in the first embodiment, a clock signal after the system clock signal and the clock signal of the Ring-OSC 15 that is not synchronous with the system clock signal are modulated is used as the shift clock signal.

Also, the external data falsification detecting system 10 in this embodiment has: a frequency setting register & interruption signal generating circuit 17 that uses the above random number and generates an interruption signal; an interruption control circuit 18 for controlling an interruption operation of the CPU 11 in accordance with the interruption signal generated by the frequency setting register & interruption signal generating circuit 17; and a command monitoring circuit 19 for monitoring a command executed by the CPU 11 and an address under which the command is executed.

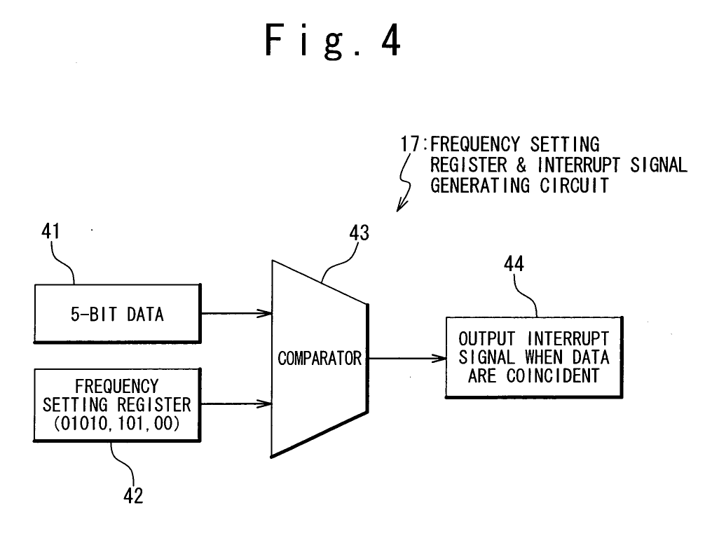

FIG. 4 shows the schematic configuration of the frequency setting register & interruption signal generating circuit 17. The frequency setting register & interruption signal generating circuit 17 has a 5-bit data input unit 41 for receiving a 5-bit data; a frequency setting register 42; and a comparator 43. The 5-bit data input unit 41 receives a random number data of 5 bits among the random numbers of 26 bits generated by the random number generator 16. Any value of 5 bits, 4 bits and 3 bits is set in advance for the frequency setting register 42. Then, the value from the frequency setting register 42 and the data from the 5-bit data input unit 41 are supplied to the comparator 43. The comparator 43 compares the value from the frequency setting register 42 and the data from the 5-bit data input unit 41. The bit length (5 bits, 4 bits and 3 bits) to be compared can be selected in accordance with the user program 12b. As the bit length becomes shorter, the frequency of the coincidence in the comparator becomes higher. If the comparator 43 detects the coincidence, an interruption signal 44 is outputted to the interruption control circuit 18. By setting the value to be set for the frequency setting register 42 of the frequency setting register & interruption signal generating circuit 17, it is possible to change the frequency of an interruption control signal outputted from the interruption control circuit 18 and freely control the frequency of the falsification detection of the external data. Also, in the first embodiment, whether or not the falsification detection of the external data during the system operation should be carried out can be set in accordance with the setting of the interruption control circuit 18. If it is determined based on the setting of the interruption control circuit 18 that the falsification detection process is important, or if it is determined that the timing of the process is critical, the falsification detection process for the external data during the system operation is stopped in response to an instruction or command supplied through the (input) port 20. The external I/F 14, the CPU 11, the storage unit 12, the data acquirer section 13, the ring oscillator (Ring-OSC) 15, the random number generator 16, the frequency setting register & interruption signal generating circuit 17, the interruption control circuit 18, the command monitoring circuit 19, the (input) port 20 and the (output) port 21 are connected through the bus line 22 to each other.

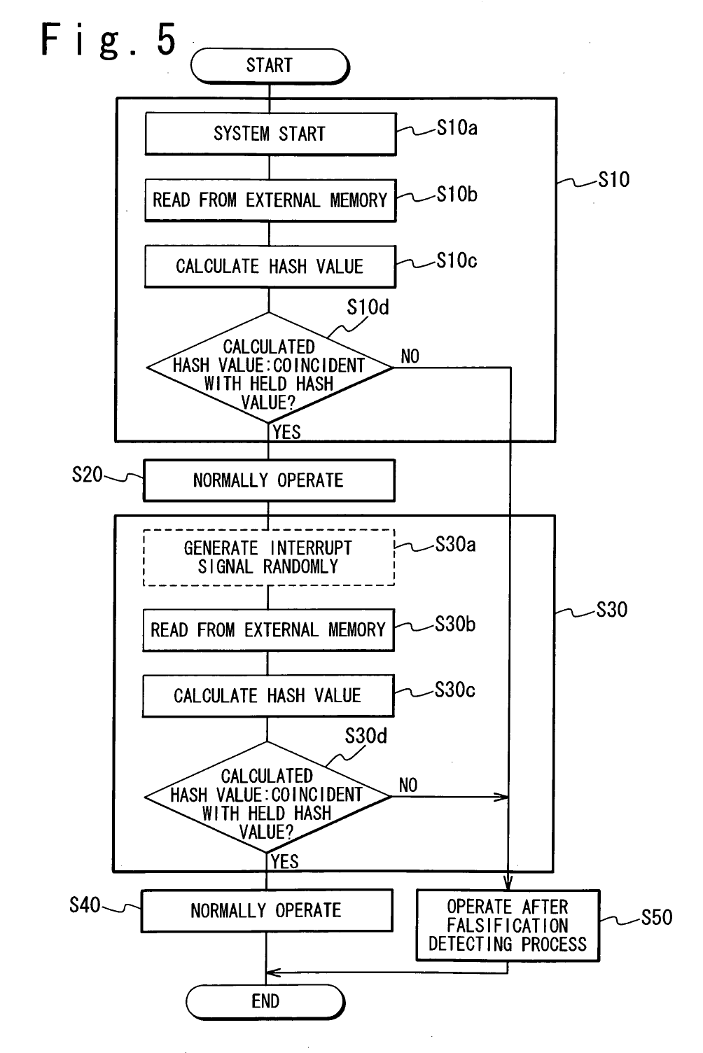

Next, an operation principle in the first embodiment will be described below in accordance with FIG. 5. When the external data falsification detecting system 10 according to the first embodiment is started, the CPU 11 reads and executes the external data falsification detecting program 12a and the user program 12b, which are stored in advance in the storage unit 12. When the external data falsification detecting program 12a is executed in the external data falsification detecting system 10 according to the first embodiment, the executions of an external data falsification detecting process (Step S10) at the time of system start and an external data falsification detecting process (Step S30) during the system operation are set.

At first, the operation flow of the external data falsification detection when the external data falsification detecting system 10 according to the first embodiment is started will be described. When this embodiment is started in accordance with an instruction supplied through the (input) port 20 (Step S10a), the data acquirer section 13 transiently reads the external data stored in the external memory 100 through the external I/F 14 and compresses and then stores in the built-in storage unit 12 (Step S10b). Then, a HASH value of this read external data is calculated (Step S10c). Then, the calculated HASH value of the external data and a normal HASH value of the external data that has been stored in advance in the storage unit 12 are compared (Step S10d). As the comparison result at the step S10d, if both of the values are coincident, the usual operation is executed in accordance with the read user application program (Step S20). On the other hand, as the comparison result at the step S10d, if both of the values are not coincident, the operation after the falsification detection is executed under the assumption that the falsification of the external data is detected (Step S50). In the operation after the falsification detection at the step S50, for example, the operation of the entire system is stopped or the interruption process is carried out. Then, the falsification of the external data is checked in accordance with the normal HASH value of the external data stored in the storage unit 12.

In this embodiment, even during the usual system operation at the step S20, the external data falsification detecting process (Step S30) similar to the external data falsification detecting process at the time of the system start (Step S10) is executed at the random timing. In the execution of the external data falsification detecting process during the system operation (Step S30), the interruption is generated by the interruption control circuit 18 at the random timing (Step S30a). At this interruption timing, the value of the frequency setting register in the frequency setting register & interruption signal generating circuit 17 is set in accordance with the user program 12b. Thus, the frequency of the timings is changed.

Also, in the first embodiment, similarly, whether or not the external data falsification detecting process during the system operation (Step S30) is executed can be set in accordance with the setting of the interruption control circuit 18 based on the user program 12b.

If a random interruption is caused during the system operation (Step S30a) by the interruption control circuit 18, similarly to the time of the system start, the data acquirer section 13 transiently reads the external data stored in the external memory 100 through the external I/F 14 and compresses and then stores in the storage unit 12 (Step S30b). Then, a HASH value of this read external data is calculated (Step S30c). Then, the calculated HASH value of the external data and the normal HASH value of the external data that has been stored in advance in the storage unit 12 are compared (Step S30d). As the comparison result at the step S30d, if both of the values are coincident, the usual system operation is executed in accordance with the read user application program (Step S40). On the other hand, as the comparison result at the step S30d, if both of the values are not coincident, the operation after the falsification detection is carried out under the assumption that the falsification of the external data is detected (Step S50).

As mentioned above, the first embodiment attains the dramatic improvement of the safety by executing the falsification detection of external data stored in the external memory 100 at the random timing, not only at the time of the system start, but also during the system operation. Also, in this embodiment, it is not required to reserve the area such as the memory to store the program stored in the external memory 100 and the like. In short, in this embodiment, the falsification detection of the external data is randomly carried out during the system operation. Therefore, it would be difficult for a hacker to estimate the timing of the execution of the data falsification detection, as compared with the case of the execution at the constant timing. As the random degree of the detection timing becomes higher, the estimation of the detection timing becomes more difficult. In this embodiment, the inclusion of the ring oscillator (Ring-OSC) 15 and the random number generator 16 attains the generation of the random number having the high random degree.

Also, the fact that the falsification detection operation is carried out during the system operation may result in the drop in the original performance of the application. Thus, in this embodiment, the execution frequency of the falsification detection operation can be set in the frequency setting register & interruption signal generating circuit 17, to match to the application to be used. Moreover, in view of the system operation state (the important process or the process where the timing is critical), when the falsification detection operation to the external memory is not desired to be executed, the interruption control circuit 18 masks this interruption signal 44 and consequently the detection operation is skipped.

In this embodiment, the execution of the detecting operation at the optimal timing (random timing) can be made possible by a switching function of the detection frequency and the skipped function without any obstruction to the normal system operation. However, this setting can be set only in accordance with the command execution based on the user program 12b stored in the built-in storage unit 12, from the viewpoint of the safety. If the command is executed from the external memory 100, the command monitoring circuit 19 senses the execution address of the command for the external memory 100, and the process flow proceeds to an operation after an illegal command detection that is set for any operation.

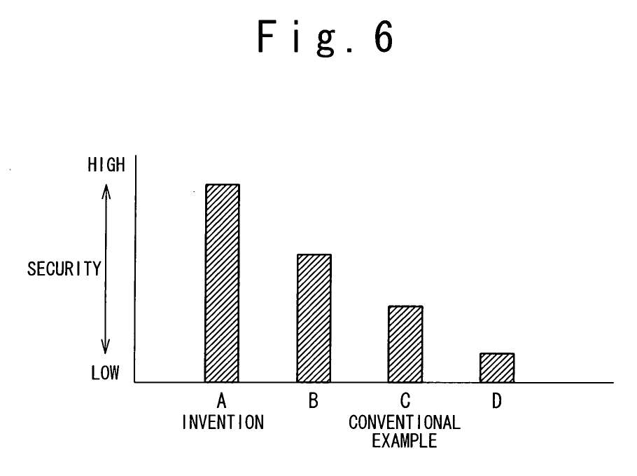

FIG. 6 shows a relative security (a risk that the external data may be falsified) between the conventional external data falsification detecting system and the external data falsification detecting system according to the first embodiment of the present invention. Here, symbols A, B, C and D indicate the following operation conditions, respectively.
(A) A case that the falsification detection to the external memory is executed at a random timing at the time of system start and during the system operation (the embodiment of the present invention);
(B) A case that the falsification detection to the external memory is executed at a constant timing at the time of system start and during system operation;
(C) A case that the falsification detection to the external memory is executed at the time of system start (the conventional example); and
(D) A case that the falsification detection unit to the external memory is not possessed.
   As shown in FIG. 6, the present invention can attain the very high safety, when the data stored in the external memory 100 is used.

### Second Embodiment

The basic configuration condition and operation principle in the second embodiment of the present invention are similar to those in the first embodiment. However, this embodiment differs in the random number generator (not shown) from the first embodiment. In short, the first embodiment uses the ring oscillator (Ring-OSC) 15 in order to increase the random number performance of the random number generator 16. However, this embodiment uses a clock signal that clock pulses are partially excluded from the system clock signal 11a, instead of the clock signal 15a generated by the ring oscillator 15.

In this embodiment, the random number degree of the random number generated by the random number generator is kept. On the other hand, as compared with a case where the ring oscillator 15 in the first embodiment is built therein, the size of the semiconductor chip having its partial function when it is installed in the microcomputer and the like can be further miniaturized.

As mentioned above, the external data falsification detecting system of the present invention:
(a) can improve the safety when the external data stored in the external memory or the like is used,
(b) can reserve the safety while suppressing the process performance drop in the system, when the external data is used,
(c) can reserve the safety without obstructing the normal operation, when the external data is used, and
(d) can reserve the safety while suppressing the increase in the chip size, when the external data is used.

According to the present invention, it is possible to provide the external data falsification detecting system, which can execute the falsification detection of the external data, not only at the time of system start of the apparatus but also during system operation, and the external data falsification detecting method.

Consequently, the safety of the system that is connected to the external storage unit and uses the external data is dramatically improved, and the large capacity of the storage unit is not required to be included inside the apparatus, and the miniaturization of the system is attained.

What is claimed is:

1. An external data falsification detecting system comprising:
a data acquirer section configured to acquire an external data at a time of system start and during system operation;
a storage unit in which a normal HASH value of the external data is previously stored; and
a comparator section configured to calculate a HASH value of the acquired external data, to compare said normal HASH value and the calculated HASH value, and to determine that the external data was falsified such that a predetermined operation limitation is carried out, when said normal HASH value and the calculated HASH value are not coincident with each other.

2. The external data falsification detecting system according to claim 1, wherein the acquisition of the external data by said data acquirer section and the calculation, comparison and determination by said comparator section during the system operation are carried out at irregular timing based on a random number.

3. The external data falsification detecting system according to claim 2, further comprising:
a random number generator having a shift register and configured to generate said random number.

4. The external data falsification detecting system according to claim 3, wherein said random number generator generates said random number in response to a first clock signal and a second clock signal which is not synchronous with said first clock signal.

5. The external data falsification detecting system according to claim 4, wherein said first clock signal is a system clock signal, and said second clock signal is obtained by excluding some clock pulses from said system clock signal.

6. The external data falsification detecting system according to claim 1, further comprising:
a frequency setting circuit configured to optionally set a frequency of the acquisition of the external data by said data acquirer section and the calculation, comparison and determination by said comparator section during the system operation.

7. The external data falsification detecting system according to claim 1, further comprising:
a check control circuit configured to control said data acquirer section and said comparator section in response to an input command.

8. The external data falsification detecting system according to claim 1, further comprising a CPU,
wherein said storage unit further stores a detection program, and
said CPU executes said detection program to operate as said comparator section.

9. A method of detecting falsification of an external data, comprising:
acquiring an external data at each of timings during a period from start to end in a system using the external data;
calculating a HASH value of the acquired external data;
comparing a normal HASH value and the calculated HASH value; and
determining that the external data was falsified such that a predetermined operation limitation is carried out, when said normal HASH value and the calculated HASH value are not coincident with each other.

10. The method according to claim 9, wherein the timings are random.

11. The method according to claim 9, further comprising:
generating random numbers; and
determining the timings based on the random numbers.

12. The method according to claim 11, wherein said generating random numbers comprises:
generating said random numbers in response to a first clock signal and a second clock signal which is not synchronous with said first clock signal.

13. The method according to claim 12, wherein said first clock signal is a system clock signal, and said second clock signal is obtained by excluding some clock pulses from said system clock signal.

14. The method according to claim 9, further comprising:
optionally setting a frequency of the timings.

15. The method according to claim 9, further comprising:
controlling said acquiring, said calculating, and said comparing in response to an input command.

16. A computer-readable software product for realizing a method of detecting falsification of an external data, said method comprising:
acquiring an external data at each of timings during a period from start to end in a system using the external data;
calculating a HASH value of the acquired external data;
comparing a normal HASH value and the calculated HASH value; and
determining that the external data was falsified such that a predetermined operation limitation is carried out, when said normal HASH value and the calculated HASH value are not coincident with each other.

17. The computer-readable software product according to claim 16, wherein the timings are random.

18. The computer-readable software product according to claim 17, wherein said method further comprises:
generating random numbers; and
determining the timings based on the random numbers.

19. The computer-readable software product according to claim 18, wherein said generating random numbers comprises:
generating said random numbers in response to a first clock signal and a second clock signal which is not synchronous with said first clock signal.

20. The computer-readable software product according to claim 16, wherein said method further comprises:
optionally setting a frequency of the timings.
